(19) United States
(12) Patent Application Publication
(10) Pub. No.: US 2006/0288378 A1
(43) Pub. Date: Dec. 21, 2006

(54) Vehicle entertainment system with quick service disconnect from headrest

(76) Inventor: Christopher J. Vitito, Celebration, FL (US)

Correspondence Address: WELSH & FLAXMAN LLC, 2000 DUKE STREET, SUITE 100, ALEXANDRIA, VA, 22314, US

(21) Appl. No.: 11/153,456

(22) Filed: Jun. 16, 2005

(51) Int. Cl. H04N 7/18

(52) U.S. Cl. 725/77; 725/74

(57) ABSTRACT

An entertainment system includes a video system mounted within a vehicle headrest, the headrest including a headrest body and a first downwardly extending extension arm including a passage therethrough. The video system includes a housing with a video monitor mounted therein. A cable is selectively secured to the video system and extends therefrom through the first extension arm.

### BACKGROUND OF THE INVENTION

1. Field of the Invention

The invention relates to a vehicle entertainment system. More particularly, the invention relates to an automobile entertainment system employing a quick service disconnect mechanism for facilitating repair and installation of the automobile entertainment system within a headrest of an automobile.

2. Description of the Prior Art

Entertainment systems for automobiles are well known. As such, many advances have been made in the development of entertainment systems that make the otherwise tedious task of riding in an automobile more bearable. In addition to the development of overhead systems pioneered by the present inventor, systems that mount within the headrest of an automobile have also been developed.

These headrest entertainment systems allow multiple individuals to view a variety of different video screens within the same vehicle. However, and as those skilled in the art will certainly appreciate, it is sometimes necessary to repair the entertainment systems. As such, a need exists for a system permitting the convenient removal of the entertainment system from the headrest for repair thereof without the complete disassembly of the system. The present invention provides such a system.

### SUMMARY OF THE INVENTION

It is, therefore, an object of the present invention to provide an entertainment system including a video system mounted within a vehicle headrest, the headrest including a headrest body and a first downwardly extending extension arm including a passage therethrough. The video system includes a housing with a video monitor mounted therein. A cable is selectively secured to the video system and extends therefrom through the first extension arm.

It is also an object of the present invention to provide an entertainment system wherein the cable includes a male connector shaped and dimensioned for selective attachment to a female connector formed in the video system.

It is another object of the present invention to provide an entertainment system wherein the video system includes a video source.

It is a further object of the present invention to provide an entertainment system wherein the video source is a DVD player.

It is also an object of the present invention to provide an entertainment system wherein the video monitor is pivotally mounted within the housing and a stop member is positioned for selectively controlling movement of the video monitor relative to the housing.

It is also another object of the present invention to provide an entertainment system wherein the housing is selectively mounted within the headrest body.

It is a further object of the present invention to provide an entertainment system wherein the video system includes a television receiver and antenna.

Other objects, advantages and salient features of the invention will become apparent from the following detailed description, which taken in conjunction with the annexed drawings, discloses a preferred, but non-limiting, embodiment of the subject invention.

### BRIEF DESCRIPTION OF THE DRAWINGS FIG. 1 is a front perspective view of an automobile entertainment system in accordance with the present invention.

FIG. 2 is a cross sectional view of the housing of the video system shown in FIG. 1.

FIGS. 3, 4, 5 and 6 are views of entertainment systems in accordance with alternate embodiments of the present invention.

FIGS. 7, 8 and 9 are various views of the housing employed in accordance with the present invention.

FIG. 10, 11, 12 and 13 are perspective views showing detachment of the video system from a headrest in accordance with the present invention.

FIG. 14 is a schematic showing wiring of the present entertainment system.

### DESCRIPTION OF THE PREFERRED EMBODIMENTS

The detailed embodiments of the present invention ate disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

With reference to the various figures, an automobile entertainment system 10 is disclosed. The automobile entertainment system 10 is composed of a series of video and audio components integrated within an automobile. Although the system is described herein for use within an automobile, those skilled in the art will appreciate that the system could be employed in a variety of vehicles, for example, boats or planes, without departing from the spirit of the present invention. In particular, the entertainment system 10 includes a video system 12 mounted within a standard headrest 14 of an automobile. The video system 12 generally includes a video monitor 16 for presenting video content and a video source 18 integrated therewith.

In accordance with a preferred embodiment, the video monitor 16 is a TFT LCD screen. However, it is contemplated that other monitor constructions, for example, plasma, Ultra High Definition VGA, touch screen VGA, organic LED, fabric based monitors (e.g., flexible TFT), etc., may be used without departing from the spirit of the present invention.

In accordance with a preferred embodiment of the present invention, the video source 18 is a DVD player coupled to the video monitor 16 for the transmission of video content thereto. That is, the DVD player 18 (or other video source) is integrated within the same video housing 20 as the video monitor 16. However, those skilled in the art will appreciate that the video source may take a variety of forms without departing from the spirit of the present invention; for example, and not limited to, satellite video systems and Bluetooth wireless based systems.

The housing 20 includes a recess 22 shaped and dimensioned for accommodating the video monitor 16. The video system 12 is mounted along the rear portion of the headrest 14 such that an individual sitting in the rear seat of the automobile may watch the material presented on the video monitor 16 without disturbing the driver of the automobile.

The video monitor 16, DVD player 18 and associated control components are mounted within the housing 20. As those skilled in the art will certainly appreciate, the video monitor 16 is mounted for viewing via the recess 22 in the housing 20. With regard to the DVD player 18, it is integrally molded within the housing 20 and positioned for insertion of the DVDs within a slot 24 behind the video monitor 16. By mounting the DVD player 18 in this way, a stable structure is developed that is well adapted for the automobile environment. It is also contemplated that a hard drive 23 video source may also be integrated with the video monitor 16. As those skilled in the art will certainly appreciate, the hard drive 23 will include inputs for receiving video content and output for transmitting video content to the video monitor 16, both of which are well known to those skilled in the art.

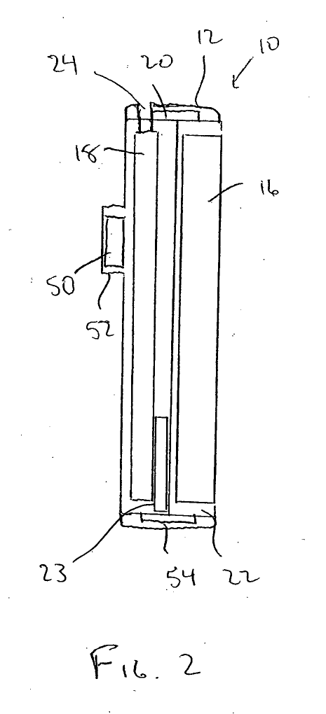

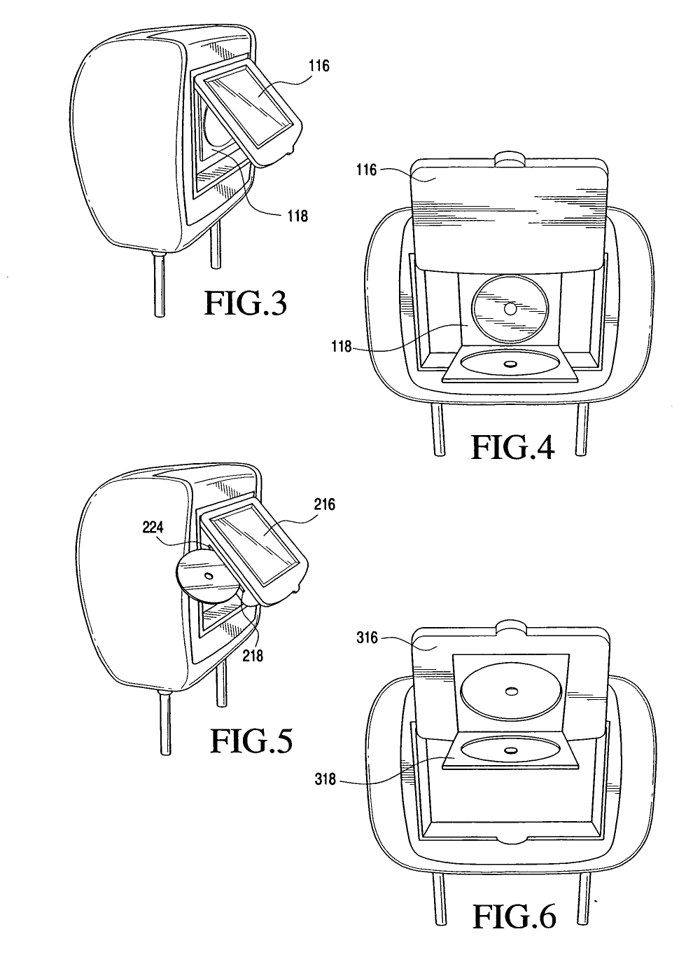

While the DVD player 18 is disclosed as being a slot-loaded design with insertion behind the video monitor, the DVD player could take a variety of other forms while still being integrated with the video monitor. With reference to FIGS. 3 and 4, the DVD player 118 may be positioned beneath the pivotally mounted video monitor 116. With reference to FIG. 5, the DVD player 218 may be integrated with the video monitor 216 and facilitate access via a side loading slot 224.

Referring to FIG. 6, the DVD player 318 is integrated within the underside of the video monitor and the DVD is snapped into the DVD player 318 when the monitor 316 is pivoted upward.

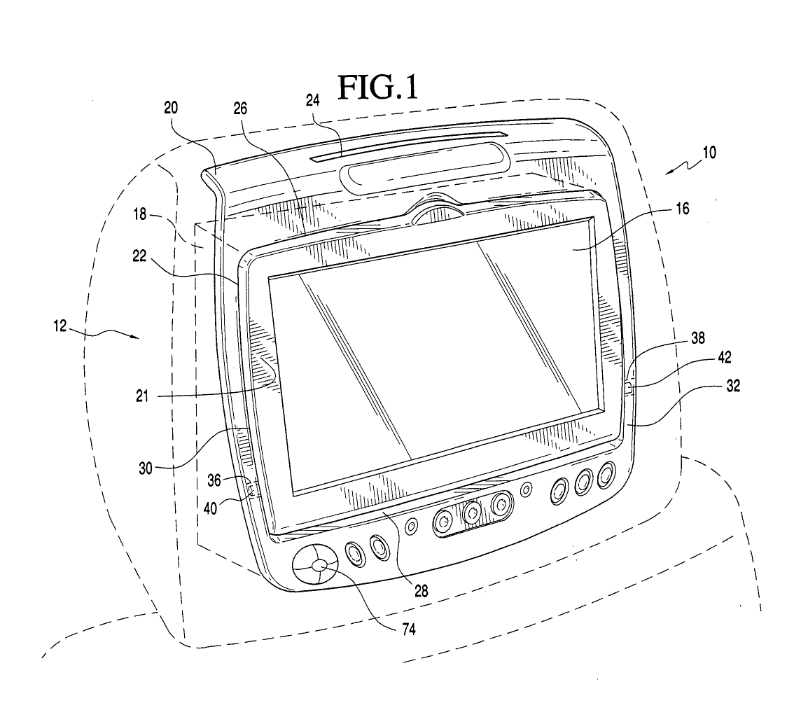

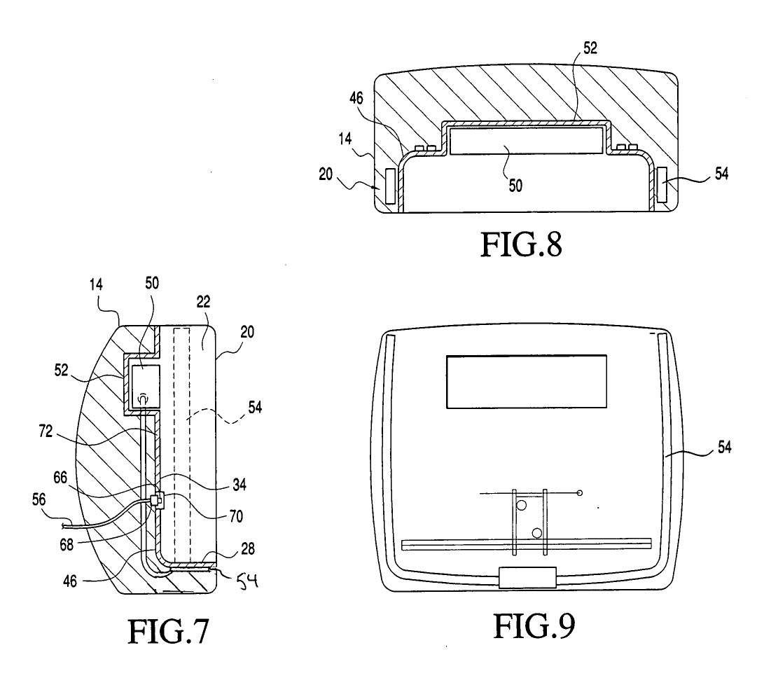

With reference to FIGS. 2 and 7 through 9, the housing 20 for the present video system 12 is disclosed. The housing 20 includes a recess 22 in which the video monitor 16, that is, the video monitor housing 21, is pivotally mounted. More specifically, the recess 22 is a generally rectangular shell in which the video monitor housing 21 is mounted. The recess 22 includes a top wall 26 and a bottom wall 28 connected by first and second sidewalls 30, 32. The recess 22 also includes a rear wall 34.

The first and second sidewalls 30, 32 are respectively provided with bearing slots 36, 38 shaped and dimensioned for receiving lateral posts 40, 42 extending from the sides of the video monitor housing 21. The lateral posts 40, 42 are preferably positioned adjacent the base of the video monitor housing 21 and the bearing slots 36, 38 are similarly positioned for receiving the posts 40, 42. In this way, the lateral posts 40, 42 are mounted within the bearing slots 36, 38 permitting controlled pivoting of the video monitor housing 21 within the recess 22.

The controlled movement of the video monitor housing 21 within the recess 22 is limited by the inclusion of a stop member 44 positioned between the video monitor housing 21 and the second sidewall 32. The stop member 44 limits movement to approximately 30 degrees of forward rotation. However, the stop member 44 may be moved between an obstruction position and a release position to permit selective full forward rotation of the video monitor housing 21 relative to the housing 20. When the stop member 44 is moved in this way, the video monitor housing 21 may be rotated fully forward making the recess 22 fully accessible for reasons that will be discussed below in greater detail.

The housing 20 is mounted within a headrest recess 46 shaped and dimensioned for receiving the housing 20 such that it is flush with the surface of the headrest 14. In accordance with a preferred embodiment of the present invention, four screws 48 are used in screwing the housing 20 within the headrest recess 46, and securing the housing 20 and video monitor 16 to the headrest. In addition, and in accordance with a preferred embodiment, a broadcast television receiver 50 is integrated with the video monitor 16 and/or the headrest 14. More particularly, and with reference to FIGS. 2 and 8 through 9, the housing 20 is provided with a television receiver rear recess 52 shaped and dimensioned for receiving a television receiver 50. The television receiver 50 may, therefore, be wired for use in conjunction with the video monitor 16 in a manner known to those skilled in the art.

The television receiver 50 is further provided with an antenna 54. The antenna 54 is electrically connected to the television receiver 50 for the transmission of over-the-air signals. The antenna 54 is substantially U-shaped and is wrapped about the housing 20. While a U-shaped antenna wrapped about the housing is disclosed in accordance with a preferred embodiment of the present invention, the antenna may be oriented within a variety of locations within the headrest without departing from the spirit of the present invention.

Although a traditional television receiver is disclosed above in accordance with a preferred embodiment of the present invention, the video system may be modified to include satellite television reception or digital television reception without departing from the spirit of the present invention.

As briefly mentioned above, the video system 12 is mounted within the headrest 14. As those skilled in the art will readily appreciate, the video system 12 is provided with inputs and outputs for audio and video. A multi-wire cable 56 extends from the output of the video system 12. The wires making up the multi-wire cable 56 include those for a power supply and the left and right audio outputs used in providing audio to an alternate audio system, for example, a wireless RF transmitter (not shown) used in transmitting sound to the vehicle audio system. The video system 12 is electrically connected to the remainder of the automobile 11 and a wireless RF transmitter (not shown) via electrical communication lines of the multi-wire cable 56 extending through the extension arm 58 of the headrest 14 and the back of the vehicle seat 60. For example, a power source wire and audio output wires are respectively connected to the video system 12 in accordance with a preferred embodiment of the present invention.

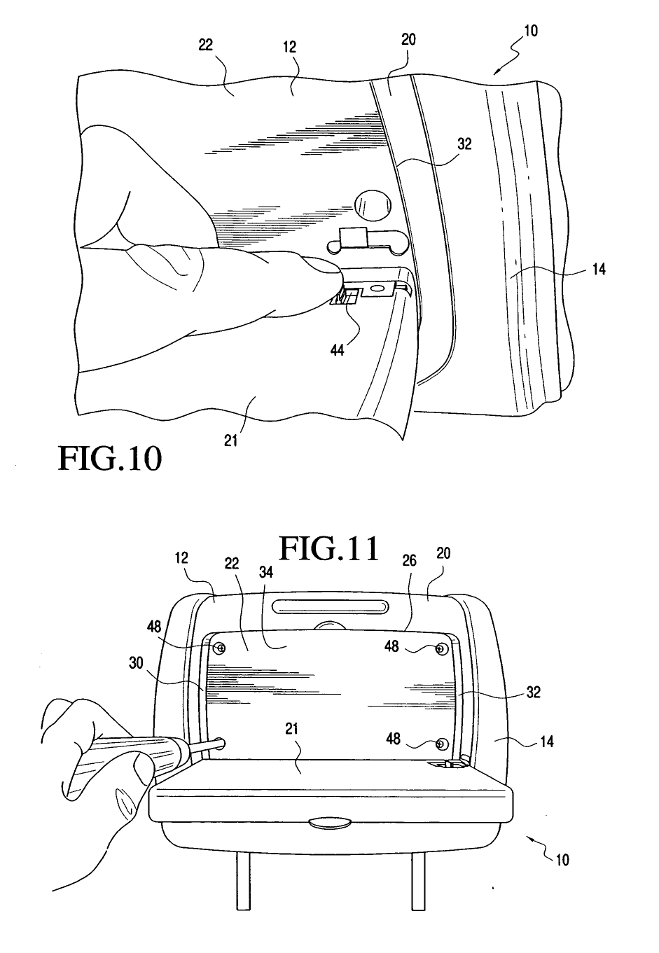

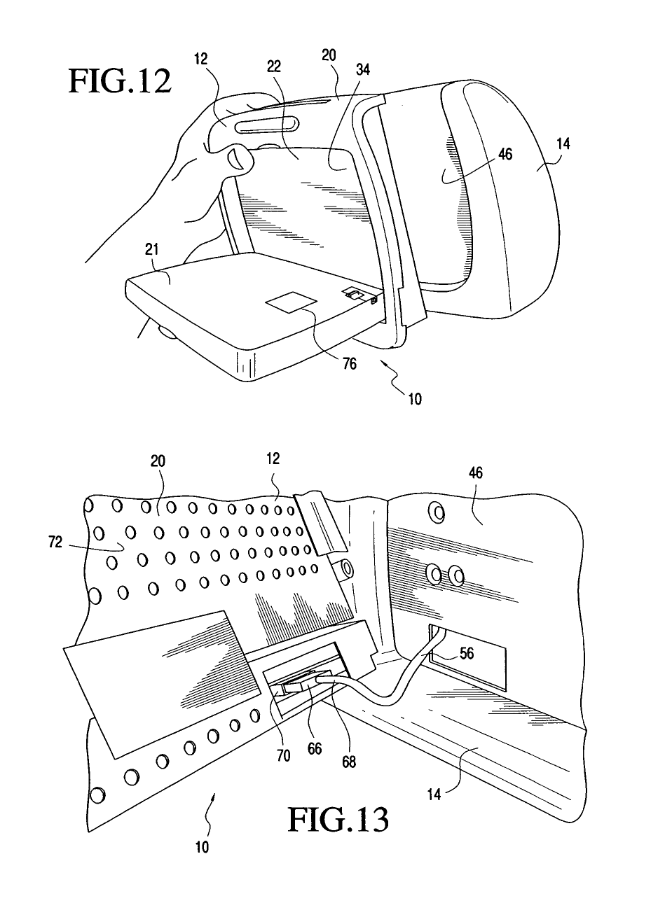

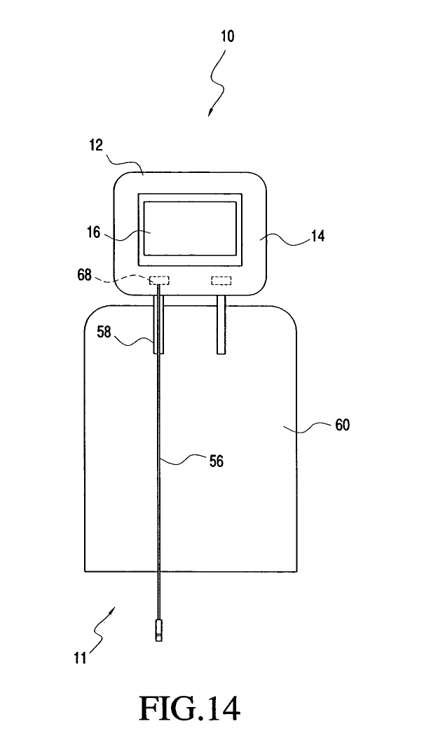

In order to facilitate ease of installation, and with reference to FIGS. 10 through 14, the multiple wires required for the power source and audio outputs are maintained within the single multi-wire cable 56. The multiple wires are passed through a single extension arm 58 of the headrest 14 with the chosen extension arm functioning as a conduit for running the multi-wire cable 56 from the video system 12 to the remainder of the automobile 11.

The multi-wire cable 56 includes a male jack 66 at its first end 68. The male jack 66 is in communication, with the electrical components (for example, power supply and audio outputs) of the video system 12 and is adapted for selective attachment to a female jack 70 formed in the back wall 72 of the housing 20. In accordance with a preferred embodiment of the present invention, traditional jacks are employed and a variety of jack structures may be employed without departing from the spirit of the present invention. In this way, the video system 12, and particularly, the housing 20, is readily detached from the external wiring of the system 10 in a manner permitting ready detachment and attachment of the video system 12 when one needs to remove the housing 20 from the headrest 14 for repair or replacement thereof

More particularly, when one wishes to remove the housing 20, and consequently the video monitor 16 and DVD player 18, the video monitor 16 is first rotated forward and the stop member 44 is moved to the release position permitting full forward rotation of the video monitor 16. The video monitor 16 may, therefore, be fully rotated forward, exposing the four screws 48 holding it within the headrest recess 46. Once the four screws 48 are removed, the housing 20 may be lifted from within the headrest recess 46, the male jack 66 of the multiwire cable 56 removed from the back wall 72 of the video system 12 and the entire video system 12 withdrawn for repair or replacement.

Passage of the multi-wire cable through the headrest extension arm and the back of the vehicle seat is described in U.S. Patent Application Serial No. 10/920,431, entitled “Automobile Entertainment System”, which is incorporated herein by reference.

Control of the video system 12, including the video monitor 16, DVD player 18 and other components of the video system 12, is facilitated by the provision of control buttons 74 along the outer surface of the video system 12. In accordance with a preferred embodiment of the present invention, the control buttons 12 take the form of a multifunction controller permitting movement of a cursor shown upon various interfaces displayed upon the video monitor 16. In addition, conventional control buttons may also be provided for control of traditional functions. In addition to the provision of manual control buttons, the video system may further include a remote control (not shown) such that an individual need not actually touch the video system to control the video content or the volume generated by the video system. Once again, and as those skilled in the art will certainly appreciate, a variety of remote control systems may be utilized without departing from the spirit of the present invention.

The present video system 12 is provided with the ability to offer a variety of functionalities. These functionalities may be hardwired or programmed within the video system or the functionalities may be added in a modular manner via an expansion slot 76 provided within the video system 12. Contemplated functionalities include, but are not limited to satellite radio (for example, Serius, XM, Pictel phone satellite television (for example, DirecTV), GPS guidance systems, quick release battery packs, memory cards, wireless internet access (for example, Wi-Fi), Bluetooth, digital video recorders, digital video reception and recording, digital video inputs, video conferencing, cellular digital, cellular digital with a camera, USB capabilities, Blue sphere, hot swap hard drive, satellite video import card, wireless video import card, etc.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. An entertainment system, comprising:
a video system mounted within a vehicle headrest, the headrest including a headrest body and a first downwardly extending extension arm including a passage therethrough;
the video system including a housing with a video monitor mounted therein, a cable is selectively secured to the video system and extends therefrom through the first extension arm.

2. The entertainment system according to claim 1, wherein the cable includes a male connector shaped and dimensioned for selective attachment to a female connector formed in the video system.

3. The entertainment system according to claim 1, wherein the video system includes a video source.

4. The entertainment system according to claim 3, wherein the video source is a DVD player.

5. The entertainment system according to claim 1, wherein the video monitor is pivotally mounted within the housing and a stop member is positioned for selectively controlling movement of the video monitor relative to the housing.

6. The entertainment system according to claim 1, wherein the housing is selectively mounted within the headrest body.

7. The entertainment system according to claim 1, wherein the video system includes a television receiver and antenna.
